(19) United States
(12) Patent Application Publication
(10) Pub. No.: US 2020/0285300 A1
(43) Pub. Date: Sep. 10, 2020

(54) ACTIVATION CONTROL DEVICE, IMAGE FORMING APPARATUS, AND METHOD FOR CONTROLLING ACTIVATION

(71) Applicants: KOHEI NISHIZAKI, KANAGAWA (JP); SHIGERU TOSA, KANAGAWA (JP); YAMATO TAKAHASHI, KANAGAWA (JP); KOHICHI SADANO, KANAGAWA (JP)

(72) Inventors: KOHEI NISHIZAKI, KANAGAWA (JP); SHIGERU TOSA, KANAGAWA (JP); YAMATO TAKAHASHI, KANAGAWA (JP); KOHICHI SADANO, KANAGAWA (JP)

(73) Assignee: Ricoh Company, Ltd., Tokyo (JP)

(21) Appl. No.: 16/800,076

(22) Filed: Feb. 25, 2020

(30) Foreign Application Priority Data
Mar. 8, 2019 (JP) 2019-043074

(51) Int. Cl. G06F 1/3293; H04N 1/00

(52) U.S. Cl. CPC G06F 1/3293; H04N 1/00896; H04N 1/00904

(57) ABSTRACT

An activation control device includes: a main CPU to be activated at a time based on a set value of an interrupt timer or when an activation factor occurs; and a sub-CPU. The main CPU adjusts the set value such that a total active time of the main CPU per predetermined time approaches a target active time, and based on a determination that adjustment of the set value alone cannot make the total active time approach the target active time, controls not to activate the main CPU for at least a part of the activation factors.

### CROSS-REFERENCE TO RELATED APPLICATIONS

This patent application is based on and claims priority pursuant to 35 U.S.C. § 119(a) to Japanese Patent Application No. 2019-043074, filed on Mar. 8, 2019, in the Japan Patent Office, the entire disclosure of which is hereby incorporated by reference herein.

### BACKGROUND

### Technical Field

The present invention relates to an activation control device, an image forming apparatus, and a method for controlling activation.

### Discussion of the Background Art

In recent years, an image forming apparatus such as a multifunction peripheral (MFP) has been required to reduce power consumption in a standby state. In view of the above, there has been a technique of reducing, in a standby state, power supply for a main central processing unit (CPU) that controls an image forming apparatus and for a random access memory (RAM) storing a program to operate in the main CPU, and reducing power consumption.

Since the operation program for the main CPU needs to be updated regularly, such as real-time clock (RTC), and the main CPU needs to be operated regularly, a sub-CPU for energy savings is provided to regularly activate the main CPU. In addition, the sub-CPU receives activation factors, such as network communication, an operation panel touch, and power button pressing, and activates the main CPU.

For example, in order to improve energy saving performance, there has been a technique in which a snapshot of the operation program of the main CPU loaded in the RAM is stored in a flash memory at the time of shifting to a low power consumption mode, power supply for the main CPU and the RAM is stopped, and in response to activation factors, the snapshot is loaded from the sub-CPU to the RAM to activate the main CPU.

### SUMMARY

Example embodiments include an activation control device including: a main CPU to be activated at a time based on a set value of an interrupt timer or when an activation factor occurs; and a sub-CPU. The main CPU adjusts the set value such that a total active time of the main CPU per predetermined time approaches a target active time, and based on a determination that adjustment of the set value alone cannot make the total active time approach the target active time, controls not to activate the main CPU for at least a part of the activation factors.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a hardware configuration diagram of an image forming apparatus according to an embodiment;

FIGS. 2A and 2B are graphs illustrating operation of a main CPU in a conventional energy saving mode;

FIG. 3 is a graph illustrating first operation of the main CPU in an energy saving mode according to the embodiment;

FIG. 4 is a graph illustrating second operation of the main CPU in the energy saving mode according to the embodiment;

FIG. 5 is a functional block diagram of an activation control device;

FIG. 6 is a flowchart of a process to be executed by the main CPU in an energy saving mode;

FIG. 7 is a graph illustrating an exemplary method for calculating a total active time in step S12;

FIGS. 8A and 8B are graphs illustrating an exemplary method for calculating a target active time in step S13;

FIG. 9 is a diagram illustrating an exemplary setting table of interrupt timer setting values in step S14;

FIG. 10 is a diagram illustrating an exemplary priority level table of activation factors in step S16; and

FIG. 11 is a flowchart of a process to be executed by a sub-CPU in the energy saving mode.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, an embodiment will be described with reference to the accompanying drawings. In order to facilitate understanding of the descriptions, the same constituent elements in the drawings are denoted by the same reference signs wherever possible, and duplicate descriptions will be omitted.

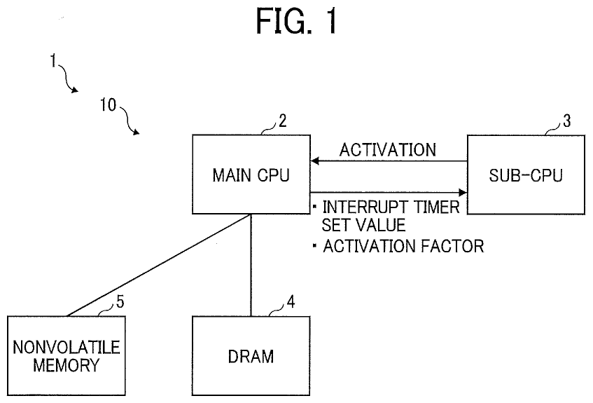

FIG. 1 is a hardware configuration diagram of an image forming apparatus 1 according to the embodiment. As illustrated in FIG. 1, the image forming apparatus 1 includes a main central processing unit (CPU) 2, a sub-CPU 3, a dynamic random access memory (DRAM) 4, and a nonvolatile memory 5. The main CPU 2 controls operation of the image forming apparatus 1. The sub-CPU 3 saves energy consumption of the main CPU 2. The DRAM 4 stores an operation program of the main CPU 2.

The main CPU 2, the sub-CPU 3, the DRAM 4, and the nonvolatile memory 5 are also included in an activation control device 10 that controls activation of the main CPU 2.

At the time of shifting to an energy saving mode, the main CPU 2 temporarily stores a snapshot of the operation program in the nonvolatile memory 5 before stopping the operation, transmits a set value of an interrupt timer to the sub-CPU 3, and stops the main CPU 2 and the DRAM 4.

The sub-CPU 3 activates the main CPU 2 when the interrupt timer or an activation factor is received.

The activation control device 10 according to the embodiment controls activation of the main CPU 2 in such a manner that a total active time of the main CPU 2 per predetermined time becomes equal to or less than a target total active time (hereinafter referred to as “target active time”) at the time of executing the energy saving mode of the main CPU 2 (hereinafter also referred to as “in the energy saving mode”). Accordingly, even in the case where activation factors of the main CPU 2 frequently occur, a decrease in the energy saving performance of the main CPU 2 can be suppressed. The predetermined time may be set according to a system designer, for example, which may correspond to a unit time.

Specifically, the activation control device 10 changes a set value of the interrupt timer depending on an operation status of the main CPU 2. For example, as the total active time of the main CPU 2 increases over the target active time, the set value of the interrupt timer is also increased to increase the interval of activation caused by the interrupt timer.

Furthermore, in a case where the target total active time cannot be achieved only by changing of the set value of the interrupt timer, the activation control device 10 skips activation factors with a low priority level to reduce the activation frequency of the main CPU 2. As a result, the target total active time can be achieved.

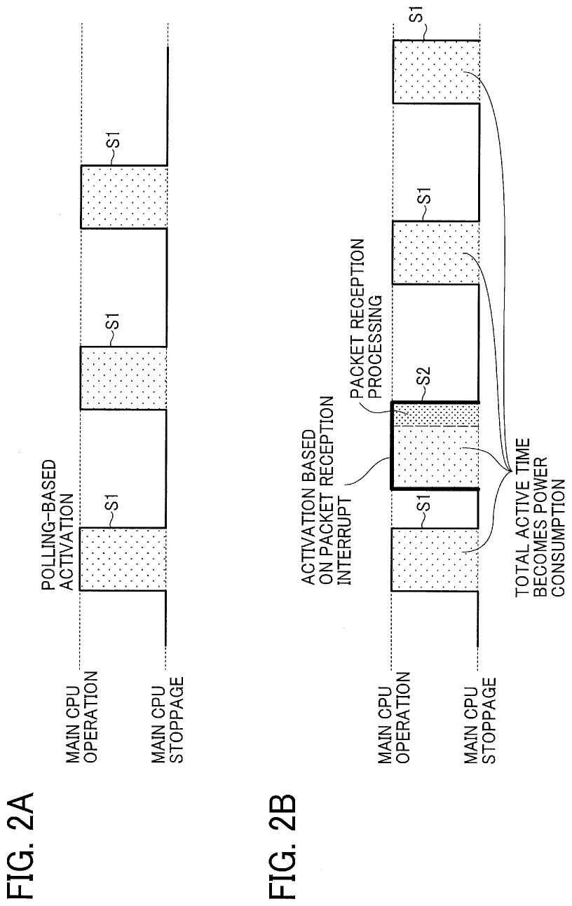

Specific operation of the activation control device 10 according to the present embodiment will be described with reference to FIGS. 2 to 4.

FIGS. 2A and 2B are graphs illustrating operation of the main CPU 2 in a conventional energy saving mode. In both of FIGS. 2A and 2B, a horizontal direction represents time, and a vertical direction represents a status of the main CPU 2 (two stages of “stopped” and “operating”). As illustrated in FIG. 2A, the main CPU 2 basically receives, from the sub-CPU 3, polling based on a set value of the interrupt timer, and repeats operation and stoppage at regular intervals. Hereinafter, this activation will be referred to as “polling-based activation”, and an interval of activation by polling will be referred to as a “polling interval”. The polling-based activation is denoted by a reference sign S1 in FIGS. 2A and 2B.

As illustrated in FIG. 2B, when an interrupt caused by some sort of activation factor (packet reception in the example of FIGS. 2A and 2B) is received, activation occurs at a timing different from the polling-based activation S1 and stoppage occurs after completion of the activation factor (e.g., after completion of the packet reception processing) as in activation S2 illustrated by a bold line in FIG. 2B. Thereafter, the polling-based activation S1 is repeated again at regular polling intervals. Accordingly, when an interrupt caused by such an activation factor occurs, operation time increases in a certain time, and the total active time per predetermined time also increases. The longer operation time indicates an increase in power consumption, which results in a decrease in energy saving performance.

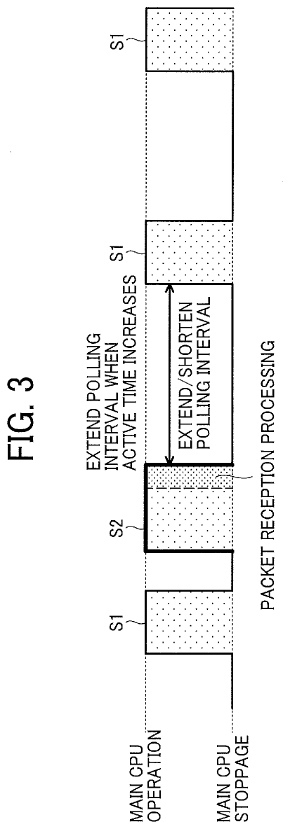

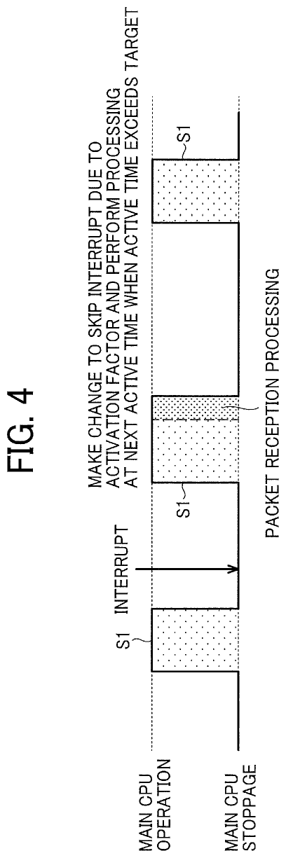

FIG. 3 is a graph illustrating first operation of the main CPU 2 in the energy saving mode of the activation control device 10 according to the embodiment. FIG. 4 is a graph illustrating second operation of the main CPU 2 in the energy saving mode of the activation control device 10 according to the embodiment. General outlines of FIGS. 3 and 4 are similar to FIGS. 2A and 2B.

As illustrated in FIG. 3, in the present embodiment, an interval of the activation time is adjusted to achieve the target energy saving performance. Specifically, the total active time of the main CPU 2 per predetermined time is monitored, and when the total active time increases, the polling interval is extended to reduce the frequency of the polling-based activation S1 so that the total active time is reduced.

Furthermore, in a case where the target energy saving performance cannot be achieved only by the adjustment of the polling interval illustrated in FIG. 3, such as a case where an interrupt caused by an activation factor frequently occurs as illustrated in FIG. 4, a change is made in such a manner that an interrupt caused by an activation factor with a low priority level is skipped and processed at the next active time. That is, activation processing is not performed when an interrupt caused by an activation factor occurs, and the skipped activation factor (packet reception in the example of FIG. 4) is executed at the polling-based activation S1 that occurs next at the predetermined polling intervals. According to the processing illustrated in FIGS. 3 and 4, the activation control device 10 according to the present embodiment can suppress a decrease in energy saving performance.

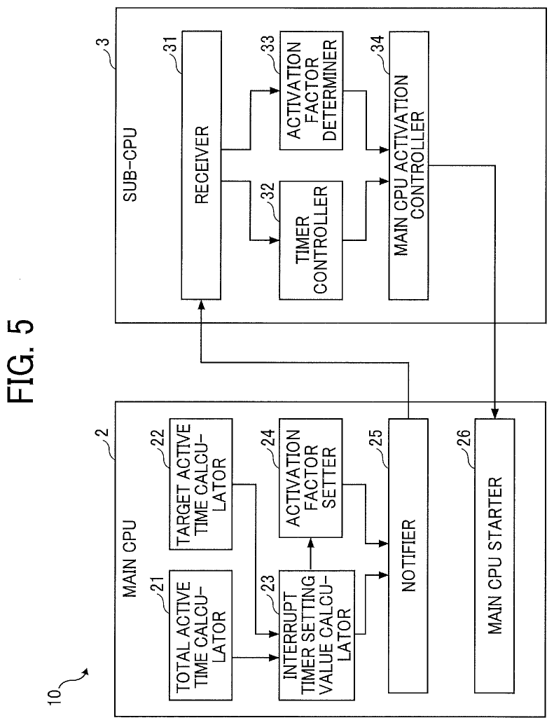

FIG. 5 is a functional block diagram of the activation control device 10. As illustrated in FIG. 5, the activation control device 10 according to the present embodiment includes, as functions for energy savings of the main CPU 2 described above, a total active time calculator 21, a target active time calculator 22, an interrupt timer setting value calculator 23, an activation factor setter 24, a notifier 25, a main CPU starter 26, a receiver 31, a timer controller 32, an activation factor determiner 33, and a main CPU activation controller 34.

The total active time calculator 21, the target active time calculator 22, the interrupt timer setting value calculator 23, the activation factor setter 24, the notifier 25, and the main CPU starter 26 are functional blocks to be executed by the main CPU 2. The receiver 31, the timer controller 32, the activation factor determiner 33, and the main CPU activation controller 34 are functional blocks to be executed by the sub-CPU 3.

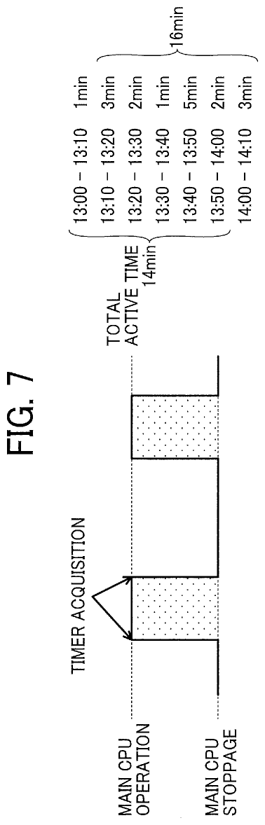

The total active time calculator 21 calculates a total active time of the main CPU 2 per predetermined time (see FIG. 7).

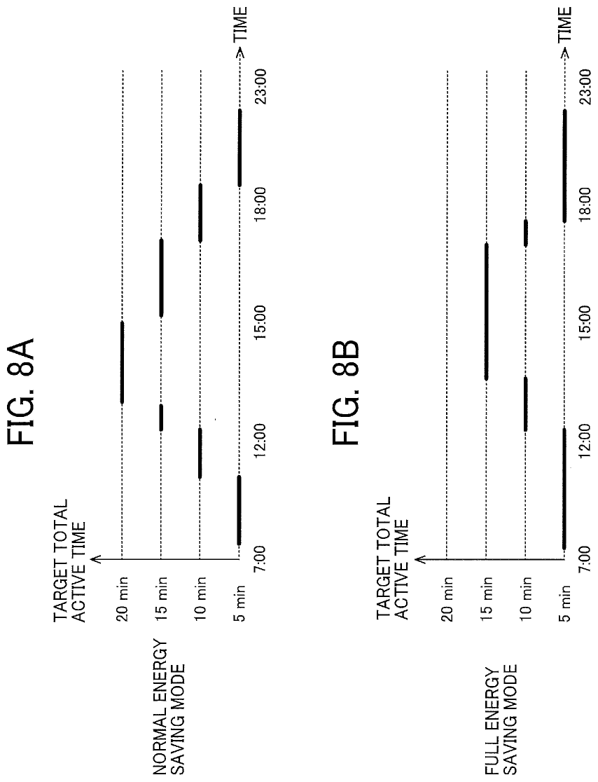

The target active time calculator 22 calculates a target active time of the main CPU 2 (see FIGS. 8A and 8B).

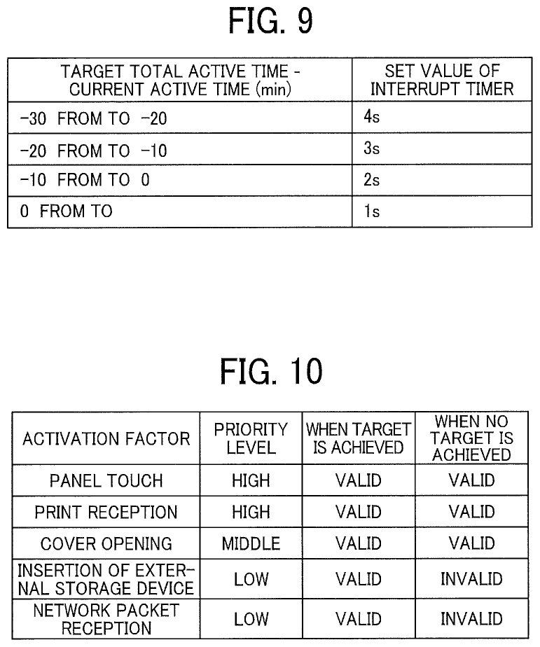

The interrupt timer setting value calculator 23 (setting value adjuster) adjusts a setting value of the interrupt timer, that is, a polling interval, in such a manner that the total active time of the main CPU 2 per predetermined time approaches the target active time (see FIG. 9).

The activation factor setter 24 sets activation of the main CPU 2 to be skipped for at least a part of activation factors in the case where the target active time cannot be achieved only by adjustment of the set value performed by the interrupt timer setting value calculator 23 (see FIG. 10).

The notifier 25 transmits, to the sub-CPU 3, an interrupt timer setting value set by the interrupt timer setting value calculator 23, and information associated with the activation factor set by the activation factor setter 24.

The main CPU starter 26 activates the main CPU 2 in response to an activation command from the sub-CPU 3.

The receiver 31 receives information from the notifier 25 of the main CPU 2.

The timer controller 32 controls the activation timing of the main CPU 2 on the basis of the interrupt timer setting value set by the interrupt timer setting value calculator 23.

The activation factor determiner 33 controls the activation timing of the main CPU 2 when an activation factor occurs. Furthermore, the activation factor determiner 33 determines, on the basis of information associated with the activation factor set by the activation factor setter 24, whether to execute or skip activation based on the activation factor when the activation factor occurs.

The main CPU activation controller 34 performs control to activate the main CPU 2 at a timing based on the set value of the interrupt timer, which is controlled by the timer controller 32, and also performs control to activate the main CPU 2 when a predetermined activation factor occurs, which is controlled by the activation factor determiner 33. The main CPU activation controller 34 transmits an activation command to the main CPU starter 26 of the main CPU 2 at a timing when the main CPU 2 should be activated.

Note that, as illustrated in FIG. 1, the activation control device 10 can be configured as a computer system including the main CPU 2, the sub-CPU 3, the DRAM 4, the nonvolatile memory 5, and the like. Each function of the activation control device 10 illustrated in FIG. 5 is implemented in such a manner that predetermined computer software (activation control program) is loaded on hardware such as the main CPU 2, the sub-CPU 3, and the DRAM 4 to cause various devices in the system to operate under control of the main CPU 2 and the sub-CPU 3, and data reading and data writing are performed in the DRAM 4 and the nonvolatile memory 5. In other words, by executing, in a computer, the activation control program according to the present embodiment, the activation control device 10 functions as the total active time calculator 21, the target active time calculator 22, the interrupt timer setting value calculator 23, the activation factor setter 24, the notifier 25, the main CPU starter 26, the receiver 31, the timer controller 32, the activation factor determiner 33, and the main CPU activation controller 34 in FIG. 5.

The activation control program according to the present embodiment is stored in a storage device included in the computer, for example. Note that a part or all of the activation control program may be transmitted via a transmission medium, such as a communication line, received by a communication module or the like included in the computer, and recorded (including installation). Furthermore, a part or all of the activation control program may be recorded (including installation) in the computer from a state of being stored in a portable storage medium, such as a compact disc read-only memory (CD-ROM), a digital versatile disc read-only memory (DVD-ROM), and a flash memory.

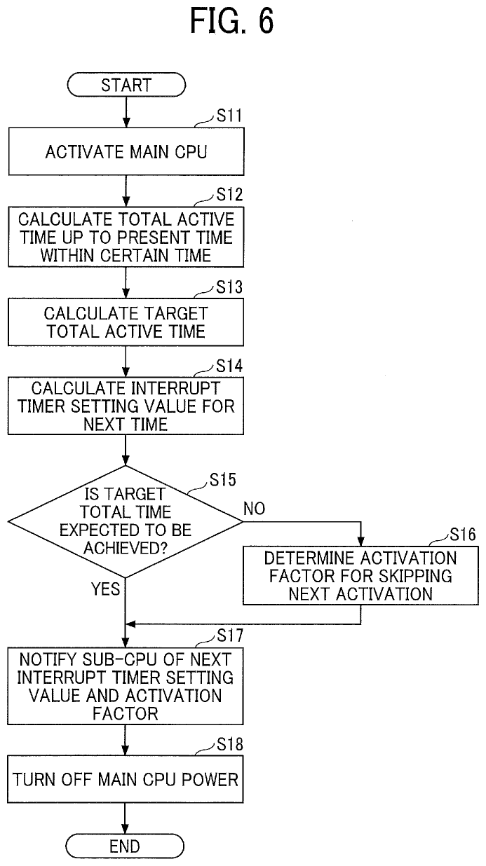

A method for controlling activation of the main CPU 2 using the activation control device 10 will be described with reference to FIGS. 6 to 11.

FIG. 6 is a flowchart of a process to be executed by the main CPU 2 in the energy saving mode. The flowchart illustrated in FIG. 6 is carried out while the main CPU 2 is active in response to a command from the sub-CPU 3.

In step S11, the main CPU starter 26 activates the main CPU 2.

In step S12, the total active time calculator 21 calculates a total active time up to the present time within a certain time.

FIG. 7 is a graph illustrating an exemplary method for calculating the total active time in step S12. As illustrated in FIG. 7, the total active time calculator 21 obtains timers immediately after activation and immediately before stoppage of the main CPU 2, and calculates an active time for one activation from the difference of the timers. As illustrated in FIG. 7, for example, the total active time for each predetermined time (e.g., 10 minutes) is calculated and retained on the basis of the calculated one active time. Then, the data of the calculated active time for each predetermined time is summed for a predetermined time (e.g., for past one hour) to calculate a total active time. In the example of FIG. 7, the total active time of six data for one hour from 13:00 to 14:00 is calculated as 14 minutes, and the total active time of six data for one hour from 13:10 to 14:10 is calculated as 16 minutes.

In step S13, the target active time calculator 22 calculates a target total active time (target active time). For example, the target active time for each time is set corresponding to an activation status of a device including the activation control device 10, and the target active time calculator 22 calculates a target active time corresponding to the current time. Accordingly, it becomes possible to set a more appropriate target active time corresponding to a time zone in consideration of a usage frequency of the image forming apparatus 1 that varies depending on a time zone.

FIGS. 8A and 8B are graphs illustrating an exemplary method for calculating the target active time in step S13. As illustrated in FIGS. 8A and 8B, the image forming apparatus 1 retains time variation data of the target active time of the main CPU 2 that varies depending on time. In addition, the image forming apparatus 1 to include the activation control device 10 has a plurality of energy saving modes that can be selected by a user, and may retain data with time variation characteristics of the target active time different for each mode, and select data to be referred to depending on an energy saving mode setting made by the user. FIGS. 8A and 8B illustrates time variation data of the target active time in two types of modes. FIG. 8A is time variation data in a normal energy saving mode, and FIG. 8B illustrates time variation data in a full energy saving mode. In the full energy saving mode, the target active time is set in such a manner that power consumption is lower than the normal energy saving mode. In each time variation data of FIGS. 8A and 8B, the horizontal axis represents time, and the vertical axis represents target active time.

As exemplified in FIGS. 8A and 8B, in the time variation data of the target active time, target values in the morning and night time zones are relatively lowered, and target values in the daytime zone are relatively increased according to the usage status of the device (image forming apparatus 1). In addition, when comparing the time variation data of FIGS. 8A and 8B, the target value in the daytime zone in the full energy saving mode in FIG. 8B is kept lower than the target value in the daytime zone in the normal mode in FIG. 8A. By setting different time variation data of the target active time for each of the plurality of energy saving modes in this manner, it becomes possible to set more detailed target active time corresponding to each mode.

In step S14, the interrupt timer setting value calculator 23 calculates an interrupt timer setting value for the next activation (setting value adjustment step). The interrupt timer setting value calculator 23 compares the current total active time calculated in step S12 with the current target active time calculated in step S13, and adjusts the setting value (polling interval) of the interrupt timer in such a manner that the total active time approaches the target active time depending on the difference between the target active time and the total active time.

FIG. 9 is a diagram illustrating an exemplary setting table of interrupt timer setting values in step S14. The activation control device 10 holds a setting value table of the interrupt timer corresponding to the current total active time and target active time as exemplified in FIG. 9, and the interrupt timer setting value calculator 23 is capable of selecting, as a new setting value, a setting value of the interrupt timer specified in the table and notifying the sub-CPU 3. In the example of FIG. 9, when the value obtained by subtracting the current total active time from the target total active time (target active time) is −30 to −20 minutes (min), in other words, when the current total active time is longer than the target active time by 20 to 30 minutes, a setting value of the interrupt timer is set to 4 seconds (s). When the value obtained by subtracting the current total active time from the target active time is −10 to 0 minutes, in other words, when the current total active time is longer than the target active time by 0 to 10 minutes, a setting value of the interrupt timer is set to 2 seconds. In this manner, as the current total active time becomes longer than the target active time, the setting value of the interrupt timer is set to be longer so that the polling interval of the activation by the interrupt timer is extended and the frequency is reduced, whereby the total active time transitions to be decreased. As described above, with the setting value of the interrupt timer being adjusted depending on the difference between the target active time and the total active time, the total active time can be more reliably suppressed, and a decrease in energy saving performance can be suppressed.

In step S15, the activation factor setter 24 determines whether or not the target active time is likely to be achieved only by the adjustment of the interrupt timer setting value in step S14. If the target active time is expected to be achieved (Yes in step S15), the process proceeds to step S17, and if achievement is not expected (No in step S15), the process proceeds to step S16.

In step S16, the activation factor setter 24 determines an activation factor for skipping the next activation (activation factor setting step). Since the target active time cannot be achieved only by the adjustment of the setting value of the interrupt timer as a result of the determination in step S15, the activation factor setter 24 changes the setting of at least a part of the activation factors to skip activation of the main CPU 2 in order to further take measures to achieve the target active time. Upon completion of the processing in step S16, the process proceeds to step S17.

FIG. 10 is a diagram illustrating an exemplary priority level table of activation factors in step S16. In the priority level table of FIG. 10, there are five specific tasks of “panel touch”, “print reception”, “cover opening”, “insertion of external storage device”, and “network packet reception”, as activation factors. In addition, priority levels (high, middle, low) are set for each task, and activation validity (valid, invalid) is set for the case where the target active time can be achieved (at the time of target achievement) and for the case where the target active time cannot be achieved (at the time of no target achievement). The main CPU 2 is activated when the activation factor occurs in the case of “valid”, and the main CPU 2 is not activated when the activation factor occurs in the case of “invalid”.

In the example of FIG. 10, “invalid” is set for the case where the target active time cannot be achieved with respect to the two types of activation factors (“insertion of external storage device” and “network packet reception”) whose priority level is set to “low”. The activation control device 10 holds a priority level table as exemplified in FIG. 10, and the activation factor setter 24 sets, as an activation factor for skipping activation of the main CPU 2, an activation factor with a low priority level in which “invalid” is set for the case where the target is not achieved in the priority level table.

In step S17, the notifier 25 notifies the sub-CPU 3 of the next interrupt timer setting value and information associated with the activation factor for skipping activation of the main CPU 2.

In step S18, the main CPU starter 26 turns off the power of the main CPU 2 to stop the main CPU 2, and the present control flow is terminated.

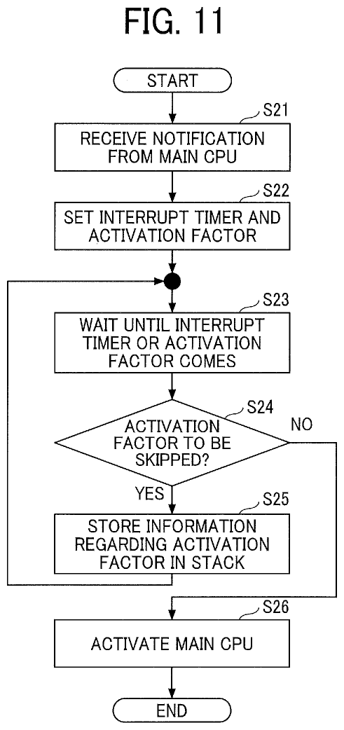

FIG. 11 is a flowchart of a process to be executed by the sub-CPU 3 in the energy saving mode.

In step S21, the receiver 31 receives the notification from the main CPU 2 transmitted in step S17.

In step S22, the timer controller 32 and the activation factor determiner 33 set the next interrupt timer setting value and the activation factor for skipping activation of the main CPU 2 on the basis of the information associated with the notification received in step S21.

In step S23, the timer controller 32 and the activation factor determiner 33 wait until an interrupt timer timing or a trigger for generating an activation factor comes, and when a trigger occurs, the process proceeds to step S24.

In step S24, if the trigger is activation factor occurrence, the activation factor determiner 33 determines whether or not the activation factor that has occurred is the activation factor for skipping activation set by the activation factor setter 24. In the case of the activation factor to be skipped (Yes in step S24), the process proceeds to step S25. Otherwise (No in step S24), the process proceeds to step S26. Note that the trigger in step S23 is the interrupt timer, the process proceeds to step S26 without performing the determination in step S24.

In step S25, the activation factor determiner 33 stores information associated with the activation factor for skipping activation in a stack. In the case of receiving the activation factor to be skipped, the activation factor determiner 33 saves the information in the stack in the activation control device 10, and the information associated with the activation factor that has saved is transmitted to the main CPU 2 at the time of next interrupt activation so that the processing for the activation factor is executed. Accordingly, the activation factor skipped for achieving the target active time can be reliably executed together with the polling activation S1. Upon completion of the processing in step S25, the process returns to step S23.

In step S26, the main CPU activation controller 34 activates the main CPU 2 in response to an interrupt timer timing or reception of an activation factor for activating the main CPU 2 (activation control step). Upon completion of the processing of step S26, the present control flow is terminated.

In the embodiment described above, activation of the main CPU is controlled even in the case where an activation factor occurs a plurality of times. Therefore, a decrease in energy saving performance can be suppressed.

The present embodiment has been described above with reference to specific examples. However, the present disclosure is not limited to those specific examples. Those in which a person skilled in the art appropriately modifies the design of those specific examples are also included in the scope of the present disclosure as long as the characteristics of the present disclosure are included. Each element included in the specific examples described above, and arrangement, a condition, a shape, and the like of the element are not limited to the described examples, and can be changed as appropriate. Each element included in the specific examples described above can be appropriately combined as long as no technical contradiction occurs.

Although the total active time calculator 21, the target active time calculator 22, the interrupt timer setting value calculator 23, and the activation factor setter 24 have been exemplified as functions to be executed by the main CPU 2 in the embodiment described above, those elements may be executed by the sub-CPU 3.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. An activation control device comprising:
a main CPU configured to be activated at a time based on a set value of an interrupt timer or when an activation factor occurs; and
a sub-CPU,
wherein the main CPU is configured to
adjust the set value such that a total active time of the main CPU per predetermined time approaches a target active time, and
based on a determination that adjustment of the set value alone cannot make the total active time approach the target active time, control not to activate the main CPU for at least a part of the activation factors.

2. The activation control device according to claim 1,
wherein the main CPU obtains a timer immediately after activation and a timer immediately before stoppage of the main CPU to calculate the total active time.

3. The activation control device according to claim 1,
wherein the target active time for each time is set corresponding to an activation status of an apparatus including the activation control device, and the main CPU calculates the target active time corresponding to current time.

4. The activation control device according to claim 1,
wherein a plurality of energy saving modes is set on an apparatus including the activation control device, and
the main CPU calculates the target active time corresponding to a mode selected from the plurality of energy saving modes.

5. The activation control device according to claim 1,
wherein the main CPU adjusts the set value according to a difference between the target active time and the total active time.

6. The activation control device according to claim 1,
wherein the main CPU temporarily stores information associated with an activation factor that has stopped activation in a memory, and
the main CPU executes processing related to the information when the main CPU is activated next time.

7. An image forming apparatus comprising:
the activation control device according to claim 1.

8. A method for controlling activation, performed by a device including a main CPU and a sub-CPU, the method comprising:
activating the main CPU at a time based on a set value of an interrupt timer or when an activation factor occurs;
adjusting the set value such that a total active time of the main CPU per predetermined time approaches a target active time; and
based on a determination that the adjusting alone cannot make the total active time approach the target active time, the method further comprising controlling not to activate the main CPU for at least a part of the activation factors.

9. The method of claim 8, further comprising:
obtaining a timer immediately after activation and a timer immediately before stoppage of the main CPU to calculate the total active time.

10. The method of claim 8, further comprising:
setting the target active time for each time corresponding to an activation status of an apparatus including the activation control device; and
calculating the target active time corresponding to current time.

11. The method of claim 8,
setting a plurality of energy saving modes on an apparatus including the activation control device; and
calculating the target active time corresponding to a mode selected from the plurality of energy saving modes.

12. The method of claim 8,
wherein the adjusting adjusts the set value according to a difference between the target active time and the total active time.

13. The method of claim 8, further comprising:
temporarily storing information associated with an activation factor that has stopped activation in a memory; and
executing processing related to the information when the main CPU is activated next time.

14. A non-transitory recording medium which, when executed by one or more processors, cause the processors to perform a method for controlling activation, performed by a device including a main CPU and a sub-CPU, the method comprising:
activating the main CPU at a time based on a set value of an interrupt timer or when an activation factor occurs;
adjusting the set value such that a total active time of the main CPU per predetermined time approaches a target active time; and
based on a determination that the adjusting alone cannot make the total active time approach the target active time, the method further comprising controlling not to activate the main CPU for at least a part of the activation factors.
